(19) United States
(12) Patent Application Publication
(10) Pub. No.: US 2020/0241535 A1
(43) Pub. Date: Jul. 30, 2020

(54) Automated Guided Vehicle Guidance System

(71) Applicant: Robocoaster Limited, Kingswinford, West Midlands (GB)

(72) Inventors: Gino De-Gol, Kingswinford, West Midlands (GB); Bruno Bolsens, Kingswinford, West Midlands (GB)

(21) Appl. No.: 16/634,484

(22) PCT Filed: Jul. 27, 2018
(86) PCT No.: PCT/GB2018/052114

§ 371 Date: Jan. 27, 2020

(30) Foreign Application Priority Data
Jul. 27, 2017 (GB) 1712097.3

(51) Int. Cl. G05D 1/02; A63G 31/02

(52) U.S. Cl. CPC G05D 1/0212; G05D 2201/0212; A63G 31/02; G05D 1/0234

(57) ABSTRACT

A method for determining the position of one or more automated guided vehicles in an environment, the method comprising: receiving from a first automated guided vehicle information comprising an initial estimate of the position of the automated guided vehicle, said initial estimate based on a vehicle position measurement system associated with the vehicle; receiving from the first automated guided vehicle safety scanner information form a contactless safety scanner associated with the vehicle, said safety scanner information comprising information regarding the presence of one or more objects within a zone outside of the vehicle monitored by the scanner; identifying, from the safety scanner information, the presence of one or more navigational markers having a predetermined size, shape, and location; and determining an updated location of the automated guided vehicle based on the received initially determined location information and the location of the one or more detected navigational markers.

### TECHNICAL FIELD

The present disclosure relates to a guidance system for automated guided vehicles, such as those used in amusement rides. Particularly, but not exclusively, the disclosure relates to a system which allows for the determination of a vehicle's position with a high level of accuracy.

### BACKGROUND

Automated Guided Vehicles (AGVs) are known in the entertainment and attractions industry. In particular such vehicles provide a dynamic movement within a confined space in a trackless environment. Such vehicles are used to carry one or more passengers. Theme park rides typically utilise passenger carrying AGVs to provide an immersive entertainment experience. The AGV moves through a themed environment and its movements are synchronised with elements of the themed environment. Such elements may include, for example, scenery, props, animatronics, audio effects, visual effects, pyrotechnic effects and olfactory effects. So as to provide maximum passenger enjoyment, the movement of the AGV is synchronised very closely with the themed environment elements. As such, it is important that the AGV does not deviate from its intended path while moving through the themed environment.

Furthermore, the movement of the passenger carrying AGV may be dynamic in order to subject the passengers to acceleration, and multi-axis movement. In certain circumstances the AGV may make complex movements (for example, accelerate, change direction and rotate simultaneously) which makes determining the position of the AGV non-trivial.

Automated, or autonomous vehicles can use simultaneous localization and mapping (SLAM) though these are complicated and may be costly to implement.

A further complication is the problem of loop-closing. When a vehicle returns to an initial position having entered a new terrain it is a non-trivial problem to update the vehicle with the information accumulated from previous visits.

In order to mitigate some of the above problems there is provided a method for determining the position of one or more automated guided vehicles in an environment, the method comprising: receiving from a first automated guided vehicle information comprising an initial estimate of the position of the automated guided vehicle, said initial estimate based on a vehicle position measurement system associated with the vehicle; receiving from the first automated guided vehicle safety scanner information from a contactless safety scanner associated with the vehicle, said safety scanner information comprising information regarding the presence of one or more objects within a zone outside of the vehicle monitored by the scanner; identifying, from the safety scanner information, the presence of one or more navigational markers having a predetermined size, shape, and location; determining an updated location of the automated guided vehicle based on the received initially determined location information and the location of one or more detected navigational markers.

There is also provided a system for determining the position of one or more automated guided vehicles in an environment, the system comprising: a first automated guided vehicle comprising: a vehicle position measurement system configured to determine an initial location of the automated guided vehicle within an environment; and a first contactless safety scanner, said safety scanner configured to detect the presence of one or more objects within a zone outside of the vehicle monitored by the scanner; one or more extended surfaces defining an outer limit of the operational envelope of operation of the automated guided vehicle, said extended surfaces comprising a plurality of navigational markers placed at predetermined locations, said navigational markers having a predetermined size and shape as to be detectable by said contactless safety scanner; and a processor configured to receive information indicative of the initially determined location and of the detected navigational markers, said processor further configured to determine an updated location of the automated guided vehicle based on the received initially determined location information and detected navigational marker information.

As such there is provided a mechanism by which the position of an AGV within an environment can be accurately determined based on the initially determined location and correcting this location based on the detection of the navigational markers. For example the AGV may rely on a known determination systems, such as inertial guidance and subsequently correct its position at various positions in the environment based on the navigational markers. Advantageously such markers (and therefore correction of the vehicle) may be placed at areas where a higher degree of precision is required. These include, but are not limited to, transition points in the environment (for example the vehicle passing through a doorway or pinch point), passenger embarkation/disembarkation points, and approaching charging points. Furthermore in the event that the vehicle loses power the navigational markers aide the vehicle to determine its location when it is subsequently restarted. Furthermore, as the invention is implemented utilising existing safety systems on the AGV the cost for implementing such a system is low and intrinsically safe.

### BRIEF DESCRIPTION OF THE DRAWINGS

One or more embodiments of the invention will now be described, by way of example only, with reference to the accompanying drawings, in which:

FIG. 1 is a schematic of a vehicle in accordance with an embodiment of the invention;

FIG. 2 is a schematic of the navigation nodes according to an embodiment of the invention;

FIG. 3 is a top down perspective view of an AGV in accordance to an aspect of the invention;

FIG. 4 is a side view of an AGV 10 having a safety sensor 38 installed thereon in accordance to an aspect of the invention;

FIG. 5 is a flow chart of the position determination system in accordance with the invention.

### DETAILED DESCRIPTION

According to an aspect of the invention there is provided an Automated Guided Vehicle (AGV) which is able to determine its position within an environment. In particular there is provided a vehicle which is configured to determine an initial location using a first location detection system, and then to supplement and correct the information based on information received by existing safety scanners associated with the vehicle.

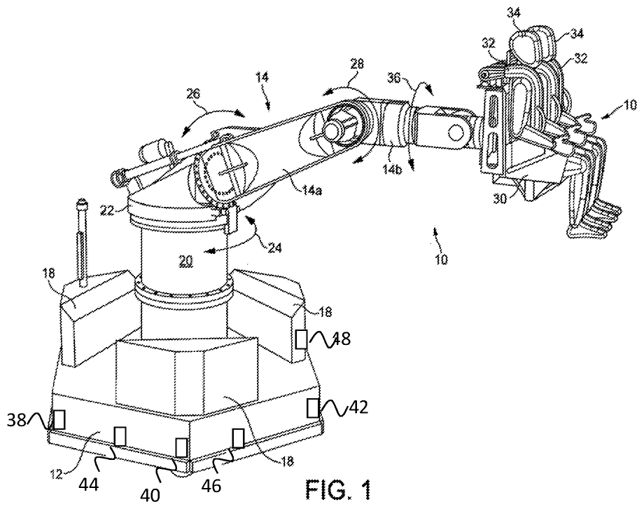

In FIG. 1, there is shown an automated guided vehicle, hereinafter referred to as an AGV, generally designated 10. In the embodiment shown, the AGV includes a base 12, an arm 14 and a passenger module 16. The configuration of the AGV 10 is shown by way of example only and is not intended to be limiting. Such an AGV in an embodiment is broadly described in WO2014191720.

The AGV is a large vehicle designed to carry one or more human passengers preferably for use in an entertainment environment. The entertainment environment may be a theme park ride, a singular or sequential dark ride show experience or cinema based experience, or the like.

The base 12 includes a number of drive units which enable the AGV 10 follow an intended path. In the embodiment shown the drive units are located in triangular projections 18 of the base 12. The base 12 further includes a central pillar 20 to which a turntable 22 of the arm 14 is optionally rotatably mounted. The arm 14 includes a lower arm portion 14a and an upper arm portion 14b which are pivotably connected to one another. The lower arm portion 14a is further pivotably connected to the turntable 22. The pivotable connection between of the arm portions 14a and 14b, and between the lower arm portion 14a and the turntable 22, together with the rotatable connection of the arm 14 to the pillar 20 enables the arm 14 to move in a plurality of directions as indicated by arrows 24, 26 and 28.

In the embodiment shown, the passenger module 16 is provided with a number of seats 30 mounted in a side by side orientation. Each seat 30 is provided with a rigid harness 32 which ensures that an occupant 34 remains in the seat 30 when the passenger module 16 is moved by the arm 14 and further when the arm 14 and passenger module 16 are moved by the base 12. The passenger module 16 is pivotably connected to the upper arm portion 14b and is movable relative to the arm 14 as indicated by arrow 36. It will be appreciated that the passenger carrying arrangement of the AGV 10 described above is illustrative of one of many different passenger carrying arrangements that may be utilised by an AGV 10 used for industrial or entertainment purposes. For example, the seats 30 may be mounted to the base 12 of the AGV 10 and the arm 14 omitted.

As is known the movement of the AGV 10 is synchronised with various thematic or cinematic events to increase the user experience.

The AGV further comprises a plurality of safety sensors 38, 40, 42. The safety sensors are preferably placed equidistant apart and have overlapping fields of view to ensure 360 degree coverage around the AGV 10. The safety sensors 38, 40, 42 are preferably performance level D (PLd) safety sensors. The sensors 38, 40, 42 are known contactless sensors which are placed approximately level with the base 12. The sensors 38, 40, 42 in an embodiment are laser PLd sensors configured to detect the presence of an object within the field of view of the sensor. Typically when an object is detected within the field of view of the sensor the distance between the object and the sensor is calculated. If the distance is below a minimum threshold it is an indication that an object (such as a person) is too close to the AGV 10 and appropriate safety measures are activated. For example the AGV 10 may enter into an automatic shutdown procedure. Such functionality and safety measures are known in the art.

As is also known in order to reduce the number of false positive events the safety sensor is configured to detect the approximate size of an object in its field of view. As such the sensors 38, 40, 42 are configured to supply raw data regarding objects in the field of view of the sensor.

Preferably the safety sensors 38, 40, 42 are configured to define a number of proximity based warning fields. Each field in an embodiment defines a different range. For example a first warning field may define a region of 50 to 99 cm from the AGV, a second warning field 100 cm to 150 cm etc. The size, and number, of fields may vary in different embodiments. Preferably the warning fields are larger than the emergency stopping fields for the prescribed maximum safe stopping distance for the proximity detected. As is known in AGVs when an object is detected within the emergency stopping field the AGV will automatically come to a halt. By defining warning fields which are larger than the emergency stopping field the AGV may detect objects within the warning field and continue operating. In an embodiment the safety scanners are able to extend the range of the safety proximity alarms generated by the safety scanners according to the speed and/or orientation of the automated guided vehicle. For example at a higher speed the size of the field is increased thus increasing the detection field of the AGV. In a further embodiment, in addition to, or separately from the changing of the size of the field according to speed and/or orientation the safety scanners are able to configure the shape and size of the safety field according to the orientation of the automated guided vehicle according to the requirements of the motion task and environment for a given position. For example where it is known that the position of the AGV within an environment requires a high degree of accuracy (for example the AGV is located in a position where it is known that multiple obstacles are present, or likely to be present) the range of the warning fields is reduced. Similarly where the vehicle is at a location with few, or no obstacles, the range of the warning is increased.

Preferably when an object is detected within a warning field the AGV will slow down. Should the obstruction, as detected in the warning field, move away or subsequently be passed by, the automated guided vehicle is able through a process of continually monitoring the proximity of the obstruction to recover to the pre-set speed assigned for the manoeuvre and continue at assigned operation, or in the case of a closing distance to the obstruction, continually reduce the speed, eventually halting if necessary.

The vehicle further comprises a number of vehicle position measurement inputs 44, 46, 48 configured to provide a measurement of the vehicle's 10 position. Such inputs 44, 46, 48 are known and include laser scanners, hi-res gyroscope, RFID tags and Encoder odometry.

The use of such inputs 44, 46, 48 are known in AGVs 10 and are not discussed further. For ease of reference three different input sources are shown but the number utilised may vary.

As such the present invention relies on existing known hardware configurations of AGVs 10 to provide the improved navigation and localisation system.

As is known in the art the vehicle position inputs provide data to a navigation system (not shown) which allows for autonomous movement through an environment. As such systems are known and their principles of operation will not be discussed further. Over time the vehicle position inputs 44, 46, 48 such as odometry are known to drift leading to inaccuracies. The amount of drift is also known to increase during complex vehicle motions which AGVs will typically undergo when used in entertainment rides. Further additional motion effects may also be added to the AGV motion and navigational inputs.

The present invention utilises the raw data from the safety sensors 38, 40, 42 to supplement the vehicle position input data to provide a high resolution localisation and mapping system for AGVs. As described in further detail below, a number of navigational markers of a predetermined size and shape are placed along the path plan and environment in which the AGV travels. The present invention advantageously but not exclusively utilises the data from the safety sensors (which are typically used to detect the presence of humans) to identify the location of the predetermined markers. The navigational markers are placed at known locations which allow for the correction of the vehicle position inputs. Advantageously, the navigational markers in a preferred embodiment are low profile markers meaning that they are unobtrusive and would not be noticed by the users of the AGV as this may detract the user from entertainment environment. The AGV in an embodiment comprises a processor (not shown), said processor configured to perform the method as described below. To determine the position of the AGV In a further embodiment the AGV comprises communication means, such as a transceiver, and communicates with a central controller 90. The central controller 90 is further configured to perform the method described below to determine the position of the AGV.

Therefore the invention provides a mechanism in which existing hardware configurations of the AGV 10 can be adapted to provide an improved navigation and localisation mapping system.

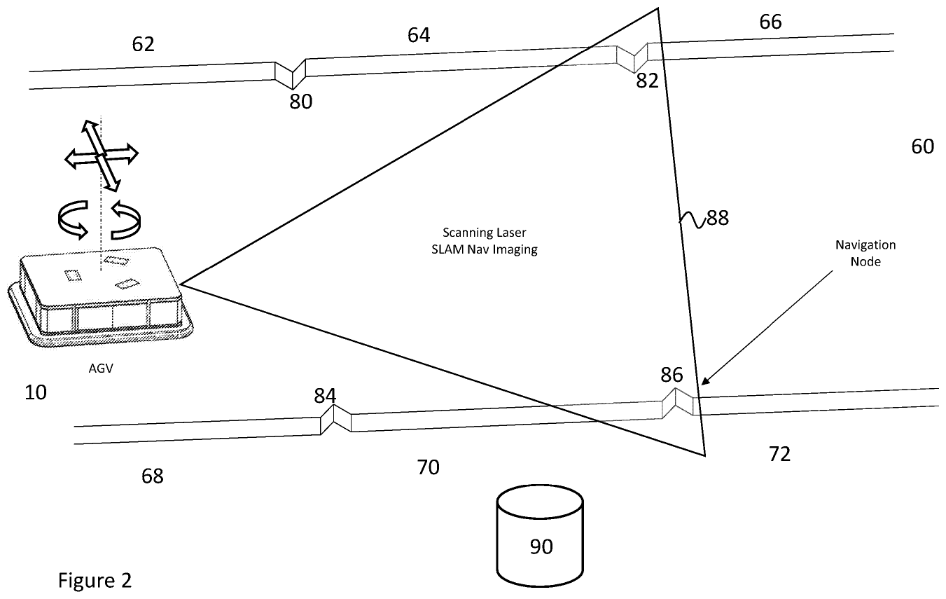

FIG. 2 is a schematic of an AGV within a navigation environment.

The navigation environment defines the environment in which the AGV typically operates. As is known, in particular in the context of an entertainment ride the AGV will follow a set/predetermined path. As stated above the motion of the AGV along the path is also synchronised with various thematic or cinematic events to increase the user experience.

Thus the AGV will travel along a predetermined operational path with a defined motion envelope in which motion and events occur.

As is known, in particular in entertainment settings, the outer perimeter of the environment for the AGV is defined by a series of low profile boards or structures, such structures being able to be made of a variety of materials to suite the application of the operating or themed environment, and are typically made of wood of steel.

In FIG. 2 there is shown an AGV 10, moving through an environment 60, the environment defined at the outer edge by a series of boards 62, 64, 66, 68, 70, 72. The boards are preferably low profile, typically less than 20 cm in height, so as to be unobtrusive in the environment 60. There is also shown a central controller 90.

The boards 62, 64, 66, 68, 70, 72 have a plurality of navigational markers 80, 82, 84, 86 which are fixed onto the boards. The navigational nodes/markers have a predefined shape and size. In some embodiments the markers have identical shapes and sizes and in further embodiments multiple predefined sizes, shapes and colours are used for the markers. In a preferred embodiment the markers are of the same colour, for example grey which is found to provide an ideal balance of signal remission and visibility in high performance areas.

The markers 80, 82, 84, 86 are placed at predetermined positions within the environment 60 and are detected by the safety sensors of the AGV 10. As the markers have a known, preferably predetermined, shape and size the markers are easily identifiable from the raw data of the safety sensors. In particular, the skilled person will understand that as the markers have a known size and shape it is possible to readily identify when a marker is within the field of view 88 of the sensor.

Each marker 80, 82, 84, 86 is installed at a known, recorded, location within the environment. As the AGV 10 has a number of vehicle position inputs, such as odometry, an initial estimate of the vehicle position can be made whilst the AGV 10 moves through the environment 60. Thus when a marker is detected by the safety sensors it is possible to identify which marker has been detected based on the estimated position of the AGV from the vehicle position determining means. In further embodiments where the individual markers have different sizes and shapes the size and shape of the marker is used to identified the marker. In further embodiments a marker is associated with an identifier, such as an RFID tag, allowing for the marker and or vehicle to be readily identified.

Preferably the markers are positioned such that the safety sensors on the AGV are able to detect multiple markers at the same time. Furthermore the security sensors, in a preferred embodiment, are positioned so as to provide 360 degree coverage around the AGV 10, and thus when the AGV 10 moves through the environment 60 different sensors may see the same marker at different times. As the positions of the markers are known it is possible to determine the location of the AGV from the detected markers with a high level of accuracy. This information can be used to correct the vehicle position information as initially determined from the vehicle position inputs thus allowing for a more accurate localisation and mapping.

In an embodiment the navigational markers are placed in areas where a higher degree of precision for the movement of the AGV is required. As the AGV is a large vehicle designed to carry humans, there is an inherent safety requirement with the need for accurate position determination. Thus at locations such as transition points in the environment (for example when the AGV passes between two rooms or through a feature or restriction), or passenger embarkation/disembarkation points, charging points etc., a higher number of navigational markers or a larger multi-faceted feature are used to allow for more accurate position determination.

A further advantage of the above configuration is that as the markers are known in location, issues regarding loop-closing may be overcome as the navigational markers allow for the AGV 10 to determine its location with a high degree of accuracy. Thus the use of the navigational markers allows for the AGV's location to be determined and successfully close the loop.

As described with reference to FIG. 1 the AGV has associated with it a navigation system to allow the AGV to autonomously move through the environment. Furthermore, the movement of the AGV 10 is typically synchronised with various thematic or cinematic events in the environment 60. Thus with the updated positional information the navigational systems of the AGV 10 may be updated and corrected to take into account the more accurately determined location based on the detected navigational markers.

A further advantage of the use of the navigational markers is that they can be installed at low cost within the environment. Unlike beacons which can be used in SLAM techniques the navigational marker of the present invention does not require any electronics, or electrical components, and in preferred embodiments the navigational markers are made from shaped wood or plastic. Furthermore, as the environment is dynamic with moving vehicles etc., the navigational markers are preferably constructed so as break away from the board upon which it is fixed in the event that the marker is knocked by an AGV or other object.

In an embodiment, the central controller 90, in a known computing device (such as desktop computer, server etc.) which is in communication with all the AGVs within the environment. The central controller 90 communicates with the AGVs 10, in an embodiment, via known communication protocols, and can issue commands to all the AGVs, or each AGV individually in a known manner. For example in the event of an emergency situation the central controller can issue an emergency shutdown command to stop all AGVs 10 within the environment 60. In a further embodiment the central controller 90 can command all AGVs log current position when a fault occurs, or re-acquire the current position in order to be able to return to a predetermined re-start or recovery position.

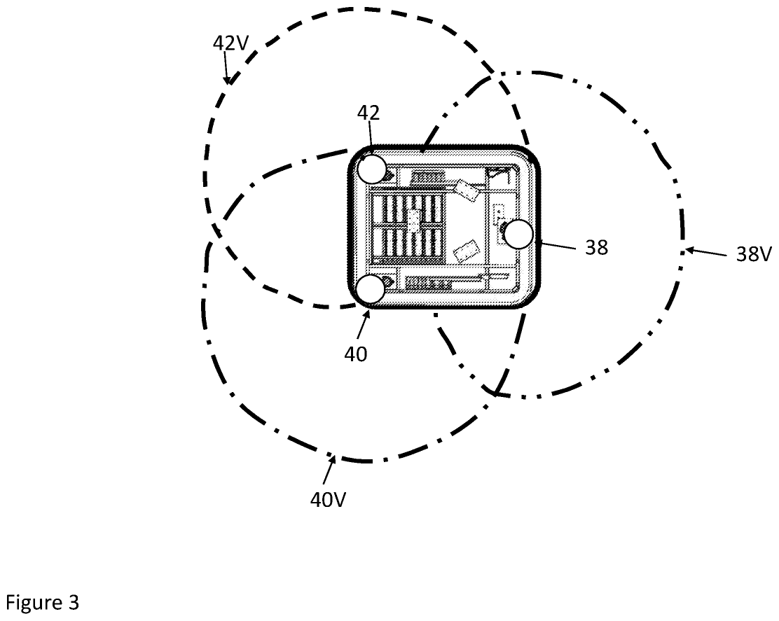

FIG. 3 is a top down perspective view of an AGV in accordance to an aspect of the invention.

In FIG. 3 there is shown the AGV 10, as described with reference to FIG. 1. There is also shown the three safety sensors 38, 40, 42. Each sensor has an associated field of view 38V, 40V, 42V respectively, wherein each field of view defines an envelope in which objects are detected.

As can be seen from the figure the fields of view for each sensor provide a 360 degree field of view with some overlap. As will be appreciated the amount of overlap and the shape of the envelopes is configurable by the position of the safety sensors on the AGV, and the number of sensors used. Whilst three sensors 38, 40, 42 are shown in FIG. 3 the number of safety sensors per AGV 10 may differ according to the amount of coverage and overlap desired. The overlapping mesh of safety sensors ensures all round coverage and protection whilst improving the ability to locate and navigate with an environment.

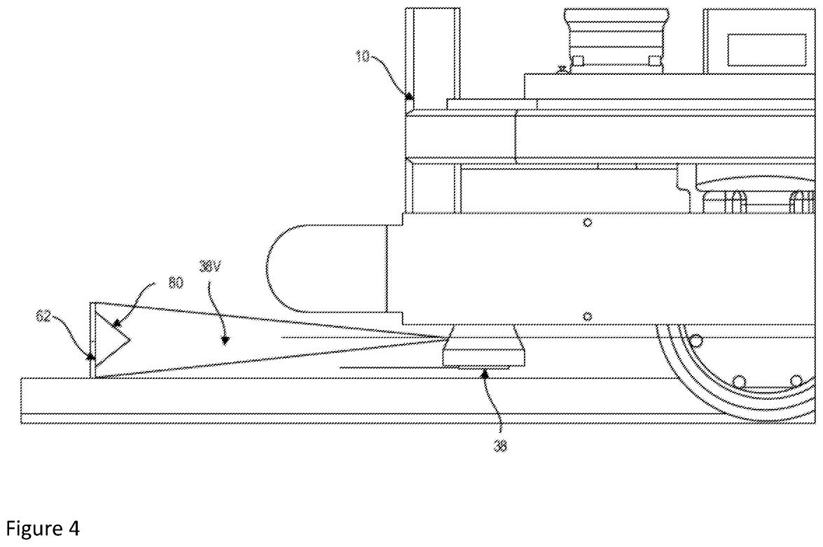

FIG. 4 is a side view of an AGV 10 having a safety sensor 38 installed thereon. The safety sensor 38 is configured to detect a board 62 and navigational marker 80 in the field of view 38V of the sensor.

In FIG. 4 there is shown the AGV 10. The nature of the AGV 10 is as discussed in relation to FIG. 1. In further embodiments other types of AGV are used. For the ease of understanding only a single safety sensor 38 is shown in FIG. 4.

The safety sensor has a field of view which extends in three dimensions with a range of several metres in the x and y planes and range of tens of centimetres in the z axis. This is represented illustratively as the field of view 38V of the sensor in FIG. 4.

In a preferred embodiment the sensor 38 is placed on the underside of the AGV 10 at a distance of approximately 10 cm from the surface over which is travels. This allows the sensor 38 to maintain its primary functionality as a safety sensor configured to determine when an object is close to, and in the path of, the AGV 10.

The board 62 with the navigational marker 80 having a predetermined size and shape are within the field of view of the safety sensor 38 and therefore easily detectable. In a preferred embodiment to take into account the extension in the field of view along the z axis the navigational marker 80 is approximately 20 centimetres in height.

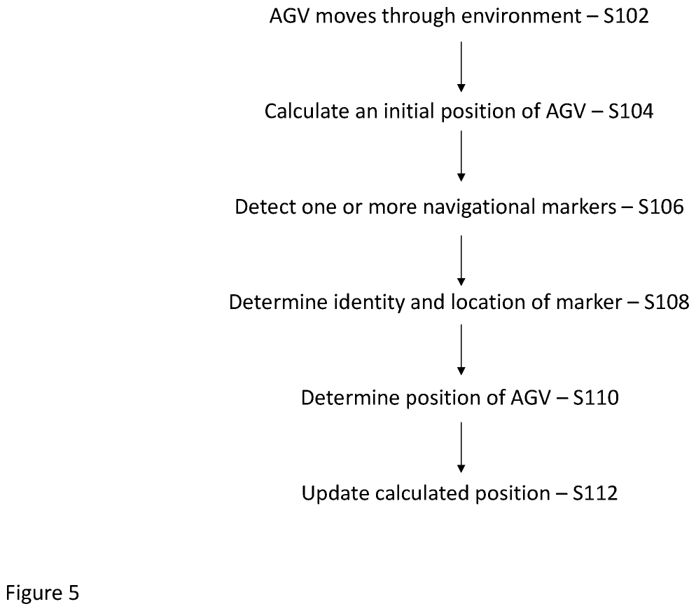

FIG. 5 is a flowchart of the process of determining the location of an AGV according to an aspect of the invention.

The method described herein is executed on one or more processors. The one or more processors in an embodiment are present on the AGV and therefore each AGV is configured to determine its position with a high degree of accuracy. In another embodiment the AGV is communication with a central controller 90, said central controller 90 having one or more processors and based on the information received from the AGV the controller determines the position of the AGV.

At step S102 the AGV 10 begins moving through the environment. As described above typically the AGV will follow a set path in order to allow the movement to be synchronised with any audio visual cue. As is known in the art the safety sensors will also be activated and collect data during movement.

At step S104 the on board AGV systems calculate an initial position of the AGV. In an embodiment the position is initially determined using known odometry techniques where the wheel data of the AGV (for example number of revolutions) is used to determine the position.

At step S106 the safety sensor detects the presence of one of more of the navigational markers. In a preferred embodiment the safety sensors as PLd rated sensors which are able to detect the size, shape and distance of various objects. Such sensors are used in the art to detect the presence of objects (such as humans) within a predetermined limit. As described above the size and shape of the navigational markers is known and fixed. Thus the navigational markers are readily identified.

At step S108 the identity of the navigational makers is determined. In an embodiment the identity of the marker is based on the initial position as determined at step S104. As the positions of the markers are known the identity of the marker may be determined by identifying the markers within the field of view of the safety sensor which detected the marker and the initially calculated position. The identity is determined by querying a database which stores the identity and location of all markers within the environment.

In further embodiments the identity may be determined from an intrinsic property of the marker (for example an RFID tag associated with the marker, or different markers having different predetermined shapes and sizes allowing for different markers to be discriminated).

At step S110 the location of the marker is used to determine the location of the AGV. As the location of the one or more markers are known, and the distance to the markers are determined from the safety sensor it is possible to determine the location of the AGV. The skilled person would understand that the more navigational markers that are detected at one time the more accurate the determined location. In practice given the location information determined at step S104 it is possible to accurately determine the position based on the detection of one or two markers. In a preferred embodiment given the multi-axis nature of the movement of the AGV the position of the AGV corresponds to the centre of gravity of the AGV.

At step S112 the determined position (as per step S110) is compared to the initially calculated position (as per step S104) and preferably the offset determined. The position of the AGV is updated to reflect the newly calculated position. Steps S110 and S112 in an embodiment are performed on a processor associated with the AGV. In a further embodiment steps S110 and S112 are performed at a processor associated with a central controller, where the initially determined position (S104) and information regarding the detected markers (S106) is sent to the central controller to enable the controller to perform the calculations.

In a preferred embodiment to take into account the complex motions of the AGV the AGV has a high precision gyroscope in order to account for the rotational and translational motion of the AGV. Such high precision gyroscopes are used to more accurately determine the initial position of the AGV when moving through the environment. Such gyroscopes are known and commercially available.

Accordingly, the invention provides a system in which existing hardware on the AGV is used in conjunction with low cost markers to provide a mechanism in which to accurately determine the position of the AGV.

As well as providing an efficient, cost effective, mechanism through which an AGV 10 may be guided within an environment 60, the present invention provides several other advantages for large AGVs designed to carry human passengers.

Due to their size, AGVs comprise an inherent safety risk which must be carefully managed. The present system utilising existing safety sensors, can allow for the accurate positional determination of the AGV 10 within the environment 60. Advantageously the extra accuracy provided by the navigational markers allows the AGVs to perform autonomous tasks within the environment.

Where the environment is an entertainment environment, there are times, typically overnight, where there is little or no usage of the vehicles. At such times, the AGVs in an embodiment enters a predetermined mode which allows the AGVs to perform autonomous maintenance activities. In an embodiment the central controller 90 issues a command to all AGVs 10 to enter into a maintenance mode.

In an embodiment, one or more AGVs within the environment enter the maintenance mode. As described with reference to FIG. 5 the AGV 10 will follow a set path through the entertainment environment as part of ride. In the battery, or power module, charging mode the set path is a different path leading the AGVs to one or more charging points, and once the AGV 10 charged to a predefined waiting point.

The AGV 10 moves through the environment as described with reference to FIG. 5, but along a different predefined route. In such embodiments preferably as the AGVs 10 are intended to run totally autonomously, the AGVs 10 move at a lower speed with all on-board safety systems enabled.

In further embodiments instead of charging points the AGVs 10 move to other predefined locations, for examples maintenance ports. In an embodiment when each AGV 10 enters the maintenance mode it performs a self-diagnostic in order to determine charge energy levels, and whether or not all onboard systems are functioning. Where it is determined that the power module is below a predetermined level the AGV 10 will follow a set path to a charging station. Where it is determined that one or more systems are not functioning the AGV 10 will follow a path to a maintenance station or area, whereupon it may be serviced by an operative or technician.

In further embodiments, alternatively or in addition to the maintenance mode described above one or more of the AGVs 10 enter a cycling, or warm up mode, at a predetermined time. In such a mode the AGV 10 follows another predetermined route and performs a predetermined set of manoeuvres to test whether the AGV 10 is functioning as expected. Again the movement of the AGV along the route is as described with respect to FIG. 5. As with the maintenance mode preferably the AGV 10 moves at a low speed.

As the above described modes are intended to be fully autonomous in the event that a potential collision event, or spatial conflict event is detected, the AGVs involved (and in an embodiment all AGVs within the environment) perform a safety rated stop. That is to say the AGVs perform an emergency stop and maintain their current position. That is to say all AGVs within the environment stop moving. Each AGV 10 subsequently performs a restart in accordance with a predetermined recovery protocols depending on the modality of the interruption, (such as a building safety alarm, personnel proximity alarms or obstruction proximity alarms and control errors for example), until such time that all AGVs are moving.

A further aspect of the invention is that in the event of a complete shutdown of the AGV the navigation system described allows the AGV to orientate itself and function as intend or return to a predetermined recovery or start/re-start location for each vehicle. The AGV may shutdown, for example, in the event that there is a complete power loss in the vehicle, a need to restart the AGV, or it enters a prolonged period of inactivity. In such situations when the AGV starts up, it may not necessarily have an indication of its initial location. For example in the event of a total loss of power, or where the AGV has entered an inactive state for an extended period of time and the information regarding the position of the AGV is stored on a volatile memory then upon the restarting of the AGV such information would no longer be present. In such situations as the AGV does not have an indication of its location it is unable to follow any predetermined path.

In such situations the contactless safety scanners are used to detect at least two preferably, more, navigational markers or building profile markers or a combination thereof. In order to obtain a unique determination of the position of the AGV at least three markers are required. The determination of the position is as described with reference to FIG. 5.

When two markers are detected the AGV, in an embodiment, moves forward at low speed in order to either detect further navigational markers, or two determine with a higher degree of accuracy the position of the AGV based on the detected markers.

Preferably, once the position has been determined the AGV 10 sends its determined position to the central controller 90 which can then issue a further command to the AGV 10 to return a predetermined position (for example a holding area).

Thus the present invention provides an improved navigation methodology for autonomous guided vehicles, especially for use in entertainment environments, such as theme park rides.

1. A system for determining the position of one or more automated guided vehicles configured to carry one or more passengers in an environment, the system comprising:
a first automated guided vehicle comprising:
a vehicle position measurement system configured to determine an initial location of the automated guided vehicle within an environment; and
a first contactless safety scanner, said safety scanner configured to detect the presence of one or more objects within a zone outside of the vehicle monitored by the scanner;
the first contactless sensor configured to detect one or more extended surfaces defining an outer limit of the operational envelope of operation of the automated guided vehicle, said extended surfaces comprising a plurality of navigational markers placed at predetermined locations, said navigational markers having a predetermined size and shape as to be detectable by said contactless safety scanner; and
one or more processors configured to receive information indicative of the initially determined location and of the detected navigational markers, said processor further configured to determine an updated location of the automated guided vehicle based on the received initially determined location information and detected navigational marker information.

2. The system of claim 1 wherein the navigational markers are low profile extending from the surface at known locations.

3. The system of claim 1 wherein the information regarding the detected navigation includes information identifying the navigational marker.

4. The system of claim 3 wherein the information identifying the navigational marker is based on the initially determined location and the identities of the navigational markers within the vicinity of the initially determined location.

5. The system of claim 1 wherein the vehicle position measurement system is based on one or more of: odometry, laser scanners, hi-res gyroscope and RFID tags.

6. The system of claim 1 wherein the vehicle follows a previously determined set path.

7. The system of claim 1 wherein safety scanners are performance level D-PLd-rated safety scanners.

8. The system of claim 1 wherein a plurality of the navigational markers have a set predetermined size and shape.

9. The system of claim 3 wherein the navigational markers have different sizes and shapes.

10. The system of claim 9 wherein the detected size and shape of the navigational marker is used to determine the information identifying the navigational marker.

11. The system of claim 1 wherein the environment is an entertainment environment.

12. The system of claim 11 wherein the entertainment environment is one of a theme park ride or cinematic environment.

13. The system of claim 11 wherein the movement of the automated guided vehicles is synchronised with one or more audio visual cues provided in the entertainment environment.

14. The system of claim 1 further comprising a central controller configured to issue instructions to the one or more automated guided vehicles in the environment.

15. The system of claim 14 where in the controller is configured to issue a command to a first automated guided vehicle to cause said automated guided vehicle to enter into a maintenance mode.

16. The system of claim 15 wherein the maintenance mode causes the automated guided vehicle to follow a set path, via the navigational markers to a charging station or maintenance area.

17. The system of claim 1 further comprising the one or more extended surfaces and one or more navigational markers.

18. The system of claim 1 wherein the automated guided vehicle comprises the processor.

19. The system of claim 1 further comprising a central controller, wherein said central controller comprises the processor.

20. A method for determining the position of one or more automated guided vehicles configured to carry one or more passengers in an environment, the method for a first automated guided vehicle comprising:
receiving an initial estimate of the position of the automated guided vehicle, said initial estimate based on a vehicle position measurement system associated with the first automated guided vehicle;
receiving from safety scanner information from a contactless safety scanner associated with the first automated guided vehicle, said safety scanner information comprising information regarding the presence of one or more objects within a zone outside of the first automated guided vehicle monitored by the scanner;
identifying, from the safety scanner information, the presence of one or more navigational markers having a predetermined size, shape, and location, said navigational markers being placed at predetermined locations; and
determining an updated location of the automated guided vehicle based on the received initially determined location information and the location of the one or more identified navigational markers.

21.-23. (canceled)
